(19) United States
(12) Patent Application Publication
(10) Pub. No.: US 2008/0070690 A1
(43) Pub. Date: Mar. 20, 2008

(54) Credit Cards in a Virtual Environment

(75) Inventors: Andrew S. Van Luchene, Santa Fe, NM (US); Raymond J. Mueller, Palm Beach Gardens, FL (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/693,576

(22) Filed: Mar. 29, 2007

Related U.S. Application Data
(63) Continuation-in-part of application No. 11/676,848, filed on Feb. 20, 2007.
(63) Continuation-in-part of application No. 11/620,542, filed on Jan. 5, 2007.
(63) Continuation-in-part of application No. 11/559,158, filed on Nov. 13, 2006.
(63) Continuation-in-part of application No. 11/421,025, filed on May 30, 2006.
(63) Continuation-in-part of application No. 11/380,489, filed on Apr. 27, 2006.
(60) Provisional application No. 60/727,121, filed on Oct. 14, 2005.

(51) Int. Cl. G06F 17/00

(52) U.S. Cl. 463/42

(57) ABSTRACT

A virtual environment in which players are able to receive alerts intended to indicate the occurrence of a given event within the virtual environment. The alerts may be delivered to the player while he is playing the game via an in-game messaging service or other similar device. Alternatively the alerts may be delivered to the player via a real world communication device such as a cell phone, pager, text messaging device, or the like.

### CROSS REFERENCE TO RELATED APPLICATIONS

The present application is a continuation in part of the following applications: Ser. No. 11/676,848, “Virtual Environment with Alerts,” filed Feb. 20, 2007; Ser. No. 11/620,542, “Satisfaction of Financial Obligations in a Virtual Environment Via Virtual and Real World Currency” filed Jan. 5, 2007; Ser. No. 11/559,158, “Financing Options in a virtual Environment” filed Nov. 13, 2006; Ser. No. 11/421,025, “Financial Institutions and Instruments in a Virtual Environment,” filed May 30, 2006; Ser. No. 11/380,489, and “Multiple Purchase Options for Virtual Purchases,” filed Apr. 27, 2007. application Ser. Nos. 11/620,542, 11/559,158, 11/421,025, and 11/380,489 claim the benefit of provisional patent application No. 60/727,121, “Methods, Processes, and Systems to Enhance a Player Experience of a Video Game,” filed Nov. 14, 2005.

### BACKGROUND

Video games which are accessible to multiple players via a server or peer to peer network are well known. For example, hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. The games are often constructed such that players pay a periodic subscription price (e.g., $15 per month) rather than, or in addition to, paying a one time purchase price for the game. Often, though not necessarily, these games have no ultimate “winner” or “winning goal,” but instead attempt to create an enjoyable playing environment and a strong player community.

It would be advantageous to provide improved methods and apparatus for increasing the enjoyment and/or longevity of video games including, but not necessarily limited to MMOGs and MMORPGs.

### BRIEF DESCRIPTION OF THE DRAWINGS

FIG. 1 is a block diagram depicting a network according to an embodiment of the present disclosure.

### DETAILED DESCRIPTION

According to one embodiment, the present invention provides for a Virtual Credit Card in a virtual environment. According to various embodiments:

Virtual Purchase Total may include the total virtual cash or cash equivalent needed to purchase a virtual item or attribute at or from a virtual shop or bank in a MMPOG.

Virtual Taxes may include a percentage, flat fee or combination of percentage/flat fee applied to activity in a virtual world or massive multiplayer online game.

Virtual Title may include a software module or application or any portion thereof and/or a record in a database that indicates, stores, tracks or otherwise documents the virtual owner or owners of one or more virtual items. In an embodiment, c. Characters cannot use a virtual item unless they are first registered on the virtual title. A fee can be paid to transfer title of the item to another character.

Virtual Activity may include any activity of a player or player character that can be measured by the game server or other application.

Notification methods may include but are not limited to:
a. Email message
b. Telephone or cell phone
c. Instant Message
d. Text Message
e. Physical Mail
f. Writing a record or entry to a file or database
g. Voice mail message
h. Pager
i. Graphic, text or audio message delivered by the game on screen to the receiving player and/or delivered by another character, or NPC
j. Any combination of any of the above.

Alert may include the transfer or storage of information or otherwise communicating with, by, between or among any two or more of the following, including, but not limited to any real or virtual: a) players, b) game owners, c) game or other servers, d) player characters, e) NPC's, f) exchanges, g) game devices or controllers, h) cell phone or other communications hardware and/or networks, i) databases, j) software applications, k) legal agencies, l) governing bodies, m) software interfaces, n) and/or any combination of any of the above, which may be initiated by and/or based upon an alert event or other action.

Alert Event may include any change in, of or to any condition or state, and includes any action, opposite action, unexpected action, desire for action, or failure to act, and thus Alert Event includes, but is not limited to any one or more of:
1. When or after any one or more variables or data changes or is expected or is about to change within a game application, service, API, communications network or one or more databases, or database variables or element, e.g., a balance is reached or exceeded, including, but not limited to:
   a. time a player or character account has been active or inactive
   b. number of complaints or compliments by other players/characters for a given player/character
   c. amount of time and/or quality and/or number of times a player or player character has provided assistance or other help or tutelage to another player and/or player character
   d. amount of time and/or quality and/or number of times a player or player character spends managing, directing or otherwise controlling one or more NPC's
   e. attributes and virtual assets or debts of the player/character
   f. player or character total or frequency of purchases of virtual cash outside or within the game environment
   g. number of loans and contracts that the character has outstanding and/or their balances
   h. payment history and timeliness of payments for any loans or other payment obligations, e.g., tax or other fee payment history
   i. guild or family of the player or character
   j. number of times the character has defaulted or paid timely on a loan or other contract
   k. age of the player account
   l. age of the player
   m. real world credit scores, points, creditworthiness or payment history
   n. experience level of the player or one or more of his characters
   o. annual income of the player or one or more of his character
   p. payment history of the character
   q. production level of the character, e.g., ability or historical performance in producing objects within the game
   r. Current assets or liabilities, e.g., net worth of a player character
   s. The number of active characters in a player account
   t. The size of the character's guild or family in the game environment
   u. The age of the account of the player
   v. The virtual transaction volume of the character or player
   w. Membership status of the character, e.g., premium member vs. basic member of the video game or credit card holder status, e.g., gold or platinum members
   x. Age of the video game or credit card account,
   y. Killing monsters in a game environment
   z. Joining a Guild in a game environment
   aa. Completing a quest in a game environment
   bb. Solving or completed a game parameter in a game environment
   cc. Paying a bill timely
   dd. Failure to pay a bill when due
   ee. Randomly
   ff. Any activity or outcome or expected or desired or undesirable outcome within the game or associated with the player's and/or the any one or more of the player character's financial condition (real or virtual) and/or the credit card(s) and/or credit line(s)
   gg. How many times the player or player character requests credit or such credit is checked or held or is otherwise encumbered
   hh. A range of amounts or values or reaching or falling below a threshold associated with any of the above (as appropriate)
   ii. When or after information is transmitted and/or shared (e.g. via a communications package or other mechanism) between two or more applications, game services, servers, financial institutions, or any other entities, e.g., a message sent between two servers to settle a debt or payment.
   jj. When or after a step or procedure (e.g., of software, a script, a user-defined process) is executed, e.g. when a penalty or interest amount is charged to an account, or an action is taken by or within a game.
   kk. When or after an application or service (e.g., a software service) is started, paused, stopped, proceeds to a certain point, or is changed.
   ll. When or after an item becomes or may become available for use or sale by an NPC or Player Character and/or at any given point during construction of the item, e.g., at a construction milestone.
   mm. When or after a character has reached or may reach a certain level or has started and/or completed a certain mission or game objective or goal within a mission.
   nn. When or after a player has obtained or may obtain or fails to obtain a certain attribute or resource.
   oo. When or after a player is logged into or out of the game or another participating game, e.g., when a friend logs into a particular game, and/or when a player remains logged in or out for a given period of time.
   pp. When or after a character or NPC has been created, modified, harmed, killed or destroyed in a game, and/or some other action is taken by or otherwise affects or should have affected one or more player or player characters.
   qq. When or after a player's account or any attribute of any player character is and/or any of his financial data or other information that may be or should have been changed, added to or removed, lost or damaged.
   rr. When or after a price, fee, tax, or other financial amount changes or should have changed (e.g., increases or decreases or is established or eliminated, or is expected, calculated or projected to change).
   ss. A trend changes or should or should not have changed or is expected to change, e.g., a particular rate of spending increases or decreases.
   tt. A battle or wager is or should or should not have or is expected to be started, won or lost, or an interim objective is achieved or is not achieved.
   uu. An object or service should or should not be or is made available for sale or the price changes or is about to or is otherwise expected to change.
   vv. A marketing offer should or should not be or is generated, determined or presented.
   ww. A player should or should not or otherwise joins or retires from a game.
   xx. A player fails to or completes a task, level, challenge, duty, service, mission, etc.
   yy. A new game or version of an existing game should or should not be or is brought online or offline or is available or not available for play.
   zz. A game should or should not be or is or is expected to be turned off for servicing or is no longer available for play (temporarily or permanently, to some, certain or all players).
   aaa. A tax amount or rate should be, should not be or is created, changed, deleted, reached, falls below or increased or decreased by an amount or percentage or may soon change or is expected to change.
   bbb. An item or object is expected to and/or should or should not be or is otherwise identified, stolen, found, created, bought, sold, encumbered, used, deployed, returned, compromised, modified or destroyed.
   ccc. One more players and/or servers and/or applications wishes, determines or requests or should or expected to wish, determine or request to notify another one or more players and/or servers and/or applications via an alert message or messages and/or when or if a player responds or fails (or should fail) to respond to an alert.
   ddd. When a player is expected or should or should not be or is logged in to a system (e.g., the virtual world, an external instant messenger system).
   eee. When a date and/or time approaches, is reached or is past.
   fff. When a virtual auction should or should not or does start or is ending or has ended.
   ggg. When an item within a virtual auction should or should not or does come up for bid or has been sold or has not been sold.
   hhh. When payment is made or is or will, or should or should not become due for a virtual purchase or on any loan and/or when one or more payments are missed, or based upon a payment term, condition or type.
   iii. When a loan penalty or interest is or should or should not be applied.
   jjj. When or after a reward or point should or should not be or is assigned to a financial account or when or after a certain threshold is or should or should not be reached, e.g., when a player accrues sufficient points to purchase a desired item.
   kkk. When a player should or should not or is expected or otherwise opens, closes or applies for a loan and/or makes or fails to make a payment on a loan and/or makes the wrong or unexpected payment on a loan.
   lll. When the credit score, credit history or risk profile of a player or player character is updated or changed or changed a certain percentage.
   mmm. When or after one or more player characters, NPC's or any other real or virtual person or item moves from one (real or virtual) position to another, or from one position to a specific position, or plans to use, applies for, is expected to use or fail to use, or uses one path vs. an expected or required path, or deviates from one path to another path, or proceeds faster or slower than required or expected or not at all.
   nnn. The negative or opposite of any one or more of the forgoing.
   ooo. A partial occurrence or greater occurrence or outcome of any one or more of the forgoing.
   ppp. A change in the rate or frequency of any one or more of the forgoing.
   qqq. And/or any one or more or any combination of any of the above, which are collectively referred to as an “alert event”.

Credit Card—includes a credit instrument issued by a real or virtual world institution to a player that allows the player to make purchases by providing an account identifier (e.g. a credit card number) rather than cash or other currency. An example is a credit card like those issued by Visa, MasterCard, or American Express. For the purposes of the present disclosure, the term “Credit card” is intended in a very broad sense and is not limited to those situations in which a player's purchases are made on credit (i.e. where payments for those purchases is not due until a later time) but also includes financial instruments such as debit cards, check cards, lines of credit and the like.

Virtual credit card—a financial instrument issued in a virtual environment that acts in the virtual environment for virtual currency the way a real world credit card acts in the real world for real currency.

Real Cash Value—the value in real dollars of the virtual currency. This value can be determined by multiplying the value of a virtual currency amount by the current exchange rate to real dollars.

Total virtual obligation amount—includes the total amount of the virtual financial obligation(s) associated with a player character's account.

Virtual Contract—an enforceable agreement between a first player character and either another player character, a game server, or a third party. Some examples of virtual contracts are provided in U.S. Provisional Patent Application Ser. No. 60/652,036, and U.S. patent application Ser. Nos. 11/279,991, 11/621,050, 11/355,232, abd 11/624,662 each of which are hereby incorporated by reference in its entirety.

Virtual—in a video game environment or other intangible space.

Virtual World—a world created in an online game such as World of Warcraft, or a virtual community such as Second Life, Eve or There.com.

Virtual Creditor—a first player character or other entity who is owed a virtual obligation by a second player character.

Virtual Credit Score—a score given to player characters in a video game based on one or more of the following criteria: the virtual assets they possess, the age of the character account, the type of account, e.g. basic or premium, the available credit line of the credit card associated with the account, the existing virtual financial obligations of the player character account, the player character's payment history including days to pay, amounts overdue or delinquent, and/or the player character's real world credit score, and/or the factors used in the real world to determine a credit score.

Virtual Financial Account—a virtual account issued to a player character by a virtual bank, game server or third party where virtual cash can be deposited and withdrawn.

Virtual Financial Obligation—an agreement by a player character or entity to pay one or more game attributes to another player character, entity or game server.

Virtual Financial Intermediary—includes institutions such as, but not necessarily limited to, depository institutions, contractual savings institutions, and investment intermediaries which offer financial products and services for use within the virtual environment. The various financial intermediaries available in the virtual environment may each serve different or overlapping purposes and provide means for using, saving, borrowing and transferring currency.

Virtual Financial Obligation Value—the “in game” or virtual value of an obligation. For virtual cash (or other currency) the value may be stated as a virtual and/or real cash (or other currency) amount. For other game attributes, the value can be determined by generating a virtual cash market value for the item based on the current value in an online marketplace or exchange.

Billing Information—includes any information pertaining to billing a player for activities related to a game or virtual environment, including, but not necessarily limited to, playing the game, accessing the game, purchasing goods or services, etc. Billing information may include such real world information as a billing address, credit card account number, bank account number, pay pal account number or other payment facilitator, or the account number of any other financial entity providing a real world credit line or any other payment-related information.

Character or “player character”—a persona in a video game that is created and controlled by a player.

Avatar—the virtual representation of a player character.

Character Account—an account that tracks character attributes.

Character Attribute—any quality, trait, feature or characteristic a particular Character can have that is stored in the corresponding Character Account. Character Attributes may include, but are not be limited to:
1. A character score
2. A virtual object
3. The physical appearance of a character
4. An emblem or mark
5. A synthetic voice
6. Virtual currency
7. Virtual help points or credits
8. The ability to join groups of other players at a later time
9. A score for subsequent matching of later game parameters
10. A relationship with another character
11. A genetic profile or makeup
12. A skill or skill level
13. A ranking

Character Life—a fixed or variable, finite or infinite period of virtual or real world time that a player character can exist in a game environment.

Character Skills—includes game attributes inherent in or acquired by a player character during game play such as, but not limited to: the ability to cast (certain) spells, foretell the future, read minds, use (certain) weapons, cook, hunt, find herbs, assemble herbs into potions, mine, assemble objects into other objects, fly, and/or enchant other player characters.

Computer Generated (CGC) or Non-Player (NPC) Character—any character that is controlled by the game system and/or a computer program and/or rules established by the game system and/or a player and not by a player on a continuous basis.

Game performance parameter—includes any aspect of a Video Game by which a player character's performance can be measured. Game Parameters shall include, but not be limited to:
1. Completing all or part of a mission
2. Playing for a certain period of time
3. Winning a match against another player character or computer generated character
4. Reaching a certain level or score
5. using or obtaining an ability or technology
6. kill/death ratios
7. obtaining, creating or modifying an object
8. solving a puzzle
9. accuracy with weapons
10. effective use of the proper weapon
11. killing a certain character/creature
12. getting through or to a certain geographic area
13. decreasing or increasing Karma Points
14. getting, buying, exchanging or learning a new skill or player attribute
15. having a child
16. getting married
17. obtaining, buying, trading, producing or developing raw materials
18. producing goods or services
19. earning income
20. earning a higher rank in an army
21. winning an election among two or more player characters
22. achieving deity or other status
23. improving player character status or caste
24. assisting other player characters with any of the above
25. speed of accomplishing or changing the rate or trends of any or all of the above.

In-game Marketplace—a virtual environment where Characters can exchange items, attributes, or any other exchangeable game element.

Novice Player—any player who would generally be considered to be a “beginner” at playing the game, includes, for example, a player that is identified as requiring the help of an expert to complete a Game Parameter.

Player—a person who controls a character in a video game or other virtual environment; includes an individual who can register an account with a Video Game Central Server or within a peer-to-peer network and create Characters that can interact with other Characters in a Virtual Environment, and/or that can authorize a NPC to act on the player's behalf.

Player Account—a database, file, program, or the like that maintains player related information including, but not limited to, personal, billing, and character account information. The database, file, program etc. may be computer implemented and may reside on a Video Game Central Server or within a peer-to-peer network that hosts or manages a video game or other virtual environment.

Player Attribute—includes any attribute that can be applied to a player account. Player Attributes shall include, but not be limited to:
1. Real Currency.
2. Discount of monthly fees for playing game.
3. Monthly fee for playing a game.
4. Interest rates for use of or borrowing real or virtual cash amounts.
5. Global character attribute settings for all characters created by player across multiple games.
6. Rewards for encouraging another player to signup to play.

Video Game—a game played on a Video Game Consul that may or may not be networked to a Video Game Central Server or within a peer-to-peer network. The terms “video game” and “virtual environment” are used interchangeably.

Video Game Console—a device that allows a player to access a video game. A video game console may, but does not necessarily, comprising a CPU, memory and optional permanent storage residing at a player location that can allow for the playing of video games. Examples include, home PCs, Microsoft Xbox, and Sony Playstation.

Video Game Central Server—a CPU, memory and permanent or temporary storage that is in communication with or capable of communicating with multiple Video Game Consoles so that multiple players can access and play a video game. The multiple players may or may not be in different locations.

Massive multi player online games (MMOGs) or massive multi-player role-playing games (MMORPGs) are computer game which are capable of supporting hundreds, thousands, or millions of players simultaneously. Typically, this type of game is played in a giant persistent world where the game continues playing regardless of whether or not real players are logged in. Players commonly access these games through a network such as the Internet, and may or may not be required to purchase additional software or hardware in order to play the game. Such networks allow for people all over the world to participate and interact with each other in a virtual environment. The present disclosure provides systems and methods which contribute to the evolution and longevity of such a game.

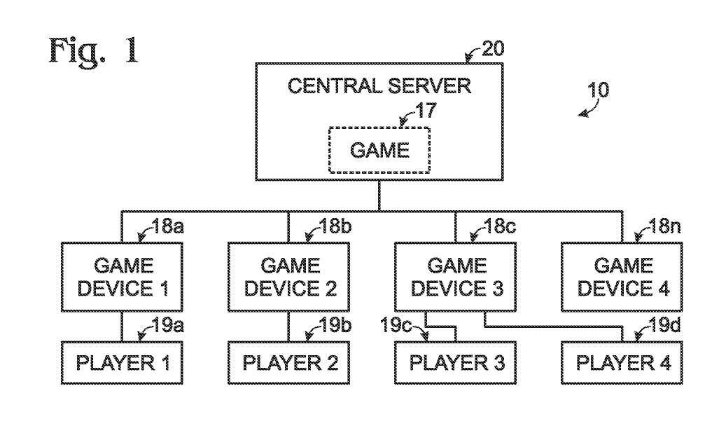

The herein described aspects and drawings illustrate components contained within, or connected with other components that permit play in the virtual environment. It is to be understood that such depicted designs are merely exemplary and that many other designs may be implemented to achieve the same functionality. Any arrangement of components to achieve the same functionality is effectively associated such that the desired functionality is achieved. FIG. 1 provides an exemplary network which may be used to support a virtual environment.

Referring to FIG. 1, a network system 10 according to one embodiment includes a central server 20 in communication with a plurality of video game playing units 18. Those of ordinary skill in the art will appreciate that any number of video game playing units may be in communication with the central server. Typically, the number of video game playing units changes at various times as players join games and as players stop playing games. Similarly, more than one server may operate to coordinate the activities of the video game playing units, as is well known in the art.

Central server 20 may comprise any computing device (e.g., one or more computers) capable of communicating with other computing devices. The server 20 typically comprises a processor which is in communication with a storage device, such as an appropriate combination of RAM, ROM, hard disk, and other well known storage media. Central server 20 may comprise one or more personal computers, web servers, dedicated game servers, video game consoles, any combination of the foregoing, or the like.

Each video game device 18 may comprise any device capable of communicating with central server 20, providing video game information to a player, and transmitting the player's desired actions to the central server. Each video game device typically comprises a processor which is in communication with a storage device, such as an appropriate combination of RAM, ROM, hard disk, and other well known storage media. Suitable video game devices include, but are not limited to, personal computers, video game consoles, mobile phones, and personal data assistants (PDAs).

Some or all of video game 17 can be stored on central server 20. Alternatively, some or all of video game 17 may be stored on the individual video game devices 18. Typically, the video game devices are able to communicate with one another. Such communication may or may not be facilitated by central server 20. Accordingly, a player 19a accessing video game 17 via game device 18a may be able to play with a player 19b accessing video game 17 via game device 18b. As shown, it may be possible for multiple players (e.g. 19c, 19d) to access central server 20 via the same game device (e.g. 18c).

Regardless of whether video game 17 is stored on central server 20 or video game devices 18, server 20 is typically configured to facilitate play of the game between multiple game players.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

As stated above, according to one embodiment, the present invention provides for a Virtual Credit Card in a virtual environment. According to this embodiment, a virtual credit card that has the same benefits as a regular, i.e., real world credit card. A player character can register and/or apply for a virtual credit card with a virtual bank or other lending institution, including a game server, player character, group of player characters, or third party credit card company, which credit card company may also be an issuer of real credit cards. The issuing party retrieves the real and/or virtual credit score and history of the player character requesting the card. Based on the credit score and history and/or other factors, a maximum virtual credit line and an interest rate is established and output to the player character. If the player character accepts the terms, a virtual credit card account is created for him and a virtual credit card is added to his inventory. The virtual credit card may include spending limits, maximum single or multiple purchase limits, preestablished or variable interest rates, reward program terms and conditions and/or other terms and conditions and/or features as determined by the lending institution and/or as agreed by and between the lending institution and the borrower.

A character can use the virtual credit card to make purchases in the game. Periodically, the issuing party may determine that a payment due based on the outstanding balance due and the specified interest rate. A real or virtual invoice and/or notice may be generated and sent to the character who holds the credit card and/or a payment can automatically be taken from the character's bank account and transferred to the lender, e.g., the credit card issuer, or the character can pay the invoice by a specified date/time due. If the character does not make the payment, pays late or does not have sufficient virtual cash in his account to make the required payment, the items he purchased with the credit card and/or additional virtual assets can be seized by the credit card issuer and/or the game server and/or resold to recoup the money.

According to an another embodiments, the virtual credit line can be secured by the credit line of a real world credit card owned by the player character and/or by one or more third parties' credit or other real world financial collateral/assets/funds. If the player character cannot make his virtual cash payments, the real cash value of those payments can be determined and charged to a real world credit card (or taken from any other real world financial account) associated with the player character account. Such real world credit cards/accounts may be owned or controlled by the player character and/or by one or more third parties.

According to a further embodiment, in the event of a payment default, another third party character player may pay (i.e., lend) the amount due in exchange for a promise to pay at a higher interest rate, and/or provide a service and/or provide the third party lender with a desired item or object or game attribute and/or under any other terms agreed upon by the defaulting player character and such third party(ies).

According to a still further embodiment, when making a purchase with a virtual credit card, or along with payment notices, or when paying a virtual credit card bill, credit card issuers or other lenders, and/or advertisers, may present one or more marketing messages to credit card holders. The message can be in the form of a virtual or printed advertisement. The advertisement can be related to the virtual purchase history of the player character. For instance, a player character who frequents a virtual casino and pays for his gambling with his credit, can be offered free credit from another virtual casino to gamble at their virtual establishment. The virtual advertisements can automatically apply rewards, discounts, and special pricing to purchases made with the advertisers using the virtual credit card.

An exemplary system 800 configured to provide a virtual environment such as that described above is shown in FIG. 2. As shown, system 800 may include a game server 802 and a credit card server 804. Game server 802 may include any suitable program including, but not limited to, a credit card account set up program 806, a periodic payment program 808, and a generate advertisements for virtual credit card invoice program 810. Credit card server 804 may include any suitable program including, but not limited to, a credit qualification program 812.

Game Server 802 may further include a plurality of databases including, for example, player database 814, a player character database 816, a virtual credit card database 818, and an advertisement database 820.

According to one embodiment, Player Database 814 may include data such as:
1. Player ID
2. Player Personal Information
3. Player Billing Information
4. Real World Credit Score
5. Player Characters 1-n

According to one embodiment, Player Character Database 816 may include data such as:
1. Character ID
2. Character Credit Score
3. Character Assets and Attributes

According to one embodiment, Virtual Credit Card Database 818 may include data such as:
1. Credit Card Number
2. Character ID
3. Virtual Balance
4. Virtual Transactions
5. Virtual Credit Line

According to one embodiment, Advertisement Database 820 may include data such as:
1. Advertisement ID
2. Advertisement Descriptor
3. Relevant Characters Characteristics
4. Relevant Player Characteristics
5. Relevant Virtual Transaction History
6. Advertisement Hyperlink
7. Advertisement Discount
8. Advertisement Virtual Fee Per Impression
9. Advertisement Virtual Fee Per Click

According to one embodiment, game server 802 may be configured to allow player characters to register for card. Accordingly, game server 802 may be configured to:
1. Receive a Request for Virtual Credit Card from a Player Character
2. Generate Virtual Credit Score for Player Credit Card
3. Determine Virtual Credit Line
4. Create Virtual Credit Card Account
5. Output account creation notice to player character (and game server if Bank Server is issuing card)

According to some embodiments, game server 802 may be configured to prequalify player characters for credit cards and offer cards to those prequalified player characters. Accordingly, game server 802 may be configured to:
1. Qualify a Player Character for a Virtual Credit Card
2. Receive Player Character Log in
3. Output Credit Card Upsell
4. Receive acceptance of upsell offer
5. Create virtual credit card account
6. Output account creation notice to player character
7. According to an alternate embodiments, game server 802 may be configured to:
8. Receive a player character log in
9. Output credit card upsell
10. Receive acceptance of upsell offer
11. Determine a virtual credit line based on player character virtual credit score
12. Create Virtual Card Account
13. Output account creation notice to player character

According to some embodiments, game server 802 may be configured to help a player character make a purchase with a virtual credit card. Accordingly, game server 802 may be configured to:
1. Receive a request to make a virtual purchase from a player character
2. Output payment options, including credit card if account exists and credit line is available
3. Receive credit card as payment choice
4. Charge virtual purchase to virtual card account
5. Mark virtual purchase as paid

According to some embodiments, game server 802 may be configured to generate an invoice and help a player character make virtual payment. Accordingly, game server 802 may be configured to:
1. Determine that a virtual payment is due for a virtual credit card
2. Generate and output a virtual invoice including a virtual payment amount and a date due to the player character
3. Receive payment on or before due date Or
4. If no payment is received by date due
5. Retrieve credit card associated with player character
6. Determine a real cash value for the virtual payment amount plus applicable fees
7. Charge real cash value to credit card
8. Convert real cash into virtual cash
9. Mark virtual payment as paid

According to some embodiments, game server 802 may be configured to help a player character make automated virtual payments. Accordingly, game server 802 may be configured to:
1. Determine that a virtual payment is due for a virtual credit card
2. Withdraw virtual payment amount from player character virtual account Or
3. If no payment is received by date due
4. Retrieve credit card associated with player character
5. Determine a real cash value for the virtual payment amount plus applicable fees
6. Charge real cash value to credit card
7. Convert real cash into virtual cash
8. Mark virtual payment as paid

According to some embodiments, game server 802 may be configured to determine advertisements for invoice. Accordingly, game server 802 may be configured to:
1. Determine advertisements for invoice
2. Generate a virtual invoice for a virtual credit card
3. Determine appropriate advertisements for credit card based on player character transaction history, player character characteristics, and player characteristics
4. Attach advertisements to invoice
5. Transmit invoice to player character including advertisements
6. Flag advertisement as sent

According to some embodiments, game server 802 may be configured to create a click through advertisement on an invoice. Accordingly, game server 802 may be configured to:
1. Receive a click on an advertisement on a virtual invoice
2. Output a web page in response to the advertisement
3. Flag advertisement as clicked

According to another embodiment, the present invention provides a virtual environment in which a player who registers to play a game on the game server or sets up an account with the bank server is offered the chance to sign up for a credit card whereby the unused credit line is used to secure deposits in the virtual bank in exchange for a monthly interest payment. The credit card can pay benefits in the form of virtual cash that are deposited into the game account of the player character as they accrue.

According to an alternate embodiment, the credit card can pay a percentage of the monthly charges in the form of virtual cash to the player character account.

According to another embodiment, only credit cards that have been issued by the game server or its bank co-brand partner can be used to secure virtual loans and or deposits in the game.

According to another embodiment, a Virtual Rewards Program may be offered to players or player characters. Player characters that make use of virtual credit cards may accumulate points based upon their usage and/or payment habits. Points may be exchanged for real or virtual objects and/or real or virtual cash. Points may be exchanged for virtual skills, favors, training or education, secrets or secret codes, that, for example, permit entry into a specific area, or solves a puzzle, or provides a hint to solve a puzzle, or provides a “get out of jail free card” or an option to “go back in time” or to improve a player's strength, or recovery rate, or to receive part or all of any maps, avatar features or upgrades, lower real or virtual interest rates, and other in game or real world products, services, devices, and the like.

According to another embodiment, virtual cash can be issued to the player character account for real world purchases made with the card.

According to an embodiment, the system may be configured to monitor activities conducted by the player and determine if any of the activities qualify as benefit-endowing activities. The benefit-endowing activities may or may not be dependant upon transactions involving the credit card. For example, and as described in greater detail below, one benefit endowing activity may be making a purchase on a credit card, while another benefit endowing activity may be winning a battle. In a further embodiment, the benefits received may be completely independent of any future credit card-based performance by the player. In other words the benefits may be given as an award for past behavior by the player and are not dependant upon the player using the credit card to pay for the benefit or promising to pay for the benefit in the future.

FIG. 3, depicts an exemplary a system 300 in which the virtual environment described above may be implemented. As shown, system 300 may include a game or bank server 302 and a credit card issuer server 304. Game or bank server 302 may include a credit card upsell program 306. Credit card issuer server 304 may include a virtual cash reward generation program 308.

According to the depicted embodiment, game or bank server 302 may further comprise a player database 310 and a player account database 312.

Player Database 310 may comprise information such as:
1. Player ID
2. Billing Info
3. Personal Info
4. Character ID 1-n

Player Account Database 312 may comprise information such as:
1. Player ID
2. Account Number
3. Credit Line Available
4. Credit Line Secured
5. Virtual Cash Payment Percentage for Secured Line
6. Virtual Cash Payment for Purchases made with Card
7. Reward Conditions
8. Transactions 1-n

Credit Card Issuer Server 304 may include a virtual cash reward account database 314, which may include information such as:
1. Account ID
2. Game Account ID
3. Reward Conditions
4. Transactions 1-n

According to one embodiment, credit Card Upsell Program 306 may be configured to:
1. Receive a player character log in
2. Determine if Player Character qualifies for a credit card based on personal info, game play behavior, billing info, real world credit score and/or virtual world credit score
3. Determine a virtual benefit for the player character if he signs up and/or uses the credit card
4. If player qualifies output credit card upsell including benefit(s)
5. Receive acceptance of upsell offer, including personal information from player character
6. Transmit personal information to credit card issuer
7. Receive new credit card account information
8. Output information to player character

According to one embodiment, Virtual Cash Reward Generation Program 308 may be configured to:
1. Receive card usage activity of a player character from card issuer
2. Determine virtual cash reward based on conditions and usage activity
3. Transmit virtual cash reward to player account

According to another embodiment, Virtual Cash Reward Generation Program 308 may be configured to:
1. Determine a real cash compensation value for the virtual cash reward
2. Transmit cash compensation value to credit card issuer for reimbursement

According to yet another embodiment, Virtual Cash Reward Generation Program 308 may be configured to:
1. Receive a virtual cash award amount for a player character from the card issuer
2. Deposit virtual cash award into player account.

According to an embodiment, Virtual Cash Reward Generation Program 338 may be configured to:
1. Retrieve usage of virtual cash reward card over a fixed time period
2. Generate a virtual reward based on conditions and card usage
3. Retrieve player character account
4. Transmit virtual cash reward to player account

According to another embodiment, Virtual Cash Reward Generation Program 338 may be configured to:
1. Output card usage activity of a player character to a game server
2. Receive a real cash compensation value from the game server
3. Transmit the real cash compensation value to the game server

According to another embodiment, the present disclosure provides a credit card that provides benefits in a MMPOG when the card holder makes purchases with the account number associated with the card. The credit card or applicable server or application may determine appropriate benefits for a player. When the player logs in to the game server, he can apply the credits/benefits earned from the credit card server to various characters associated with the player account.

Benefits may be rewarded for any one or more of the following activities, including but not limited to:
1. Opening the credit card account
2. Making purchases (real or virtual) with the card
3. Carrying a balance in real or virtual currency on the card
4. Making a certain number of purchases with the card
5. Making purchases of a certain value with the card
6. Making purchases of a certain type with the card
7. Purchasing certain items, number of items, or attributes with the card
8. Renewal of the card
9. Using the card to guarantee or otherwise secure or pay off a loan
10. Using the card to secure or pay off a loan of another player
11. Winning a battle or achieving an objective in battle
12. Finishing or starting an activity
13. Providing services in exchange for points, e.g., managing one or more NPCs and/or providing assistance to new players
14. Playing a game
15. Signing up a friend or third party to play a game
16. Signing up a friend or third party to receive their own card
17. One or more “alert events”
18. Based upon achieving or relating to one or more game objectives or goals
19. Or any combination of the above or any other activity to be rewarded as determined by the credit card issuer or by any third party willing to pay for all or part of any such reward(s)

Benefits may include any one or more of the following, including but not limited to:
1. A reduced monthly or other periodic fee to play a MMPOG (e.g., a player can play the game for free if he maintains a monthly balance of $1500 or more on the credit card)
2. Virtual cash or other credits in the game (e.g., a player can receive an amount of virtual cash each month that is equal to a certain percentage of money that he has spent with the credit card in that month)
3. Free or lower cost virtual items in the game (e.g., a player can select a certain free virtual item or attribute for his player character in the game when he has made a certain number of purchases with his real world credit card)
4. Special character selections in the game (e.g., a player can select certain special races and classes in the game if they carry a balance on their credit card associated with the game)
5. Special character attributes in the game (e.g., a player character can only have certain spells, or may receive extra “lives” or body armor, if they have a credit card or a card with a certain minimum balance)
6. Free play time, e.g., a player can receive free play time in the game environment perpetually or for a period of time if they register for a credit card and are approved and/or purchase goods with the card and/or maintain a certain minimum balance or pay on time, etc.
7. Points that may be redeemed for any of the forgoing and/or other goods, services, financial benefits, tax reductions or rebates, currency (real or virtual), etc.
8. Real items or currency, e.g., based upon a player's usage of or actual or average balance carried on the card, or as a reward for any of the activities listed above, the player may receive any of the above items, including tangible or intangible goods and services, or real items, services or currency, e.g., free real world airline tickets, or free or discounted goods, e.g., a new cell phone, etc.
9. Free or reduced cost access to game play assistance, e.g., an expert player might assist a player character to solve a puzzle
10. Use such points within the credit card's real world conversion or frequency programs.

In another embodiment, the rewards that the player has earned are presented on the login screen of the game, and the player can allocate the reward to one or more of the various player characters in his account or “gift” them to another account in part or in whole. Once the player has allocated the reward, it is made available to that character in the player account.

The player can sell the rewards to another player in the game and/or back to the rewards program at full price or at a discount as determined by the reward program and/or as agreed to by the player and the reward program.

In another embodiment, players or player characters may designate a “Preferred virtual credit card.” In this case, the preferred virtual credit card” and/or its real world counterpart's will receive points on a preferential basis over other cards. In addition or in the alternate, one or more card's points must be used before access or use of other points is granted.

The rewards can have varying values based on which character sub-account the player applies them.

A player can specify what real world dollar amount or percentage of his real world credit line can be used or allocated for virtual purchases.

Multiple virtual credit cards with different benefits can be offered to or used by the players at the same time, which offers may be based on historical play habits.

A virtual credit card can be flagged as a “preferred card”. A preferred card status would mean that the credit line is used up on this card before other virtual credit card credit lines can be used. Alternatively, the balance of this preferred card must be paid before other virtual balances of other virtual credit cards can be paid. The virtual lender can charge a lower interest rate to have the privilege of being the preferred card

Points from multiple cards may be pooled to exchange for larger or more valuable items, attributes, etc.

Benefits include:

1. Waiving the monthly fee to pay the game

2. a reduced virtual interest rate on virtual loans

3. free insurance on virtual world items

Obligations may accrue when

1. A certain number of real world transactions are made

2. A certain dollar value of real world transactions are made

Accordingly, system 10 may be configured to perform the various functions described above may incorporate one or more servers capable of running any number and/or combination of software modules configured to perform various tasks. Exemplary combinations of servers and software modules useful for the presently-described system include:

Game Server
1. Player Activity/Tracking Program
2. Rewards Notification Program
3. Rewards Allocation Program
4. Rewards Redemption Program
5. Alerts Program
6. Preferred Card Program
7. Credit Line Allocation Program
8. Credit Line Usage and Notification Program

Credit Card Server
1. Rewards Registration Program
2. Rewards Determination Program
3. Rewards Allocation Program
4. Rewards Redemption Program
5. Alerts Program
6. Credit Line Allocation Program (to set max amount of line that can be used for virtual purchases)
7. Credit Line Usage and Notification Program

System 10 may further include a number of databases configured to store and associate the various types of data that are used by the system to perform the functions described above. Exemplary database architectures useful for the presently-described system include:

Game Server

1. Player Database
a. Player ID
b. Player Personal Info
c. Player Real Currency Account Information
d. Player Character Name 1-n
e. Account created date/time
f. Characters Owned or Controlled ID 1-n

2. Player Financial Information Database
a. Player ID
b. Reward Points Total
c. Fee Plan/Preferences
d. Player Billing Information
   1. Credit Card(s) 1-n
   2. Billing Preference
   3. Account type
   4. Currency Preferences
e. Player Account Balances 1-n
   1. Current Amount Due—Total
      a. Details 1-n
         i. Date/Time
         ii. Due From ID
         iii. Due Amount
         iv. Due Currency
         v. Terms and Conditions
   2. Current Amounts Owed—Total
      a. Details 1-n
         i. Date/Time
         ii. Owed by ID
         iii. Owed Amount
         iv. Owed Currency
         v. Terms and Conditions
   3. Financial Transaction History 1-N
      a. Transaction ID
      b. Description
      c. Date/Time of Transaction
      d. Type
      e. Amount
   4. Rewards Transaction History 1-N
      a. Transaction ID
      b. Description
      c. Date/Time of Transaction
      d. Type
      e. Amount

3. Player Character Database
a. Character ID
b. Character Name
c. Title ID
d. Character Attributes 1-n
e. Character Rules 1-n
f. Virtual Cash Currency Preferences 1-n
g. Real Cash Currency Preferences 1-n
h. Virtual Cash Account 1-n
   1. Account Number 1-n
   2. Account Balance 1-n
i. Real Cash Account 1-n
   1. Account Number 1-n
   2. Account Balance 1-n
j. Credit Card Account 1-n
   1. Account Number 1-n
   2. Account Balance 1-n
   3. Reward Points Balance 1-n
   4. Redemption Activity 1-n
   5. Virtual Item ID 1-n

4. Currency Conversion Database
a. Currency ID
b. Currency Description
c. Usage Rules 1-n
d. Exchange Rate/Date 1-n
e. Exchange Fees 1-n

5. Virtual Reward Transaction Database

6. Transaction ID

7. Description

8. Type

9. Transaction Time/Date

10. Player ID

11. Character ID 1-N

12. Credit Card ID 1-N

13. Points Awarded/Deducted

Credit Card Server

1. Card Holder Database
a. Card Holder ID (e.g., Player ID)
b. Card Type (i.e. preferred)
c. Terms and Conditions/Rules 1-n
d. Interest Rate Rules 1-n
e. Penalty Rules 1-n
f. Outstanding Balance
g. Current Minimum Amount Due
h. Reward Points Total
i. Virtual Transaction Database IDs 1-n

2. Transaction Database
a. Transaction ID
b. Description
c. Transaction Time/Date
d. Player ID
e. Character ID 1-N
f. Credit Card ID 1-N
g. Financial Transaction Information
   1. Amount
   2. ID
   3. Additional Terms and Conditions 1-n
h. Reward Database Activity ID 1-n

3. Rewards Database
a. Reward Transaction ID
b. Type
c. Date/Time
d. Description
e. Unit
f. Amount
g. Additional Terms and Conditions 1-n

4. Rewards Conditions Database
a. Reward Rule ID
b. Description
c. Type
d. Vendor/Supplier ID
   1. Activity Type/ID
   2. Reward Amount
e. Rules 1-n
f. Rule Constraints 1-n

Accordingly, a system such as that described herein will be configured to perform various functions, such as those described above, by performing various method steps in order to accomplish one or more given tasks. Non-limiting examples of programs or modules that may be employed by a system according to the present disclosure include the following programs which may have the following architectures and/or capabilities:

Game Server

1. Create a reward card for a player
a. Receive a player log on
b. Determine if player is eligible for a credit card
c. Output credit card offer
d. Receive acceptance of offer including reward preferences
e. Transmit accepted offer to credit card server

2. Receive Rewards from Credit Card Server
a. Receive a reward including a reward id and a player id from credit card server
b. Determine value of award
c. Store award with player account
d. Transmit request for payment of award value to credit card server
e. Receive payment for award value from credit card server

3. Reward Distribution to Player Character
a. Receive a player log in
b. Determine if reward is available
c. Output Reward
d. Receive indication of player character to distribute reward
e. Distribute reward to player character

4. Preferred Card Usage
a. Receive a request to pay for a virtual transaction
b. Determine if player character has a preferred credit line
c. Determine if preferred credit line has open credit
d. If preferred credit line has open credit, apply transaction to preferred card.
e. If preferred credit line does not have open credit, output notice to player that preferred credit line has no available credit
f. Process transaction with other credit line on file

5. Preferred Card Payment
a. Receive a payment from a player for one or more credit lines
b. Determine if there is a preferred credit line
c. Apply payment to preferred credit line
d. Apply payment remainder (if available) to other credit lines based on terms and conditions

Credit Card Server

1. Reward Registration
a. Receive an indication that a new account has been created including a virtual reward preference
b. Create new card account including reward preferences

2. Reward Determination
a. Retrieve transaction activity
b. Determine Reward based on activity and player preference
c. Store Reward

3. Reward Issuance
a. Retrieve Reward
b. Transmit Reward record, including player id and reward id to game server
c. Receive fee for purchasing reward from game server
d. Pay fee to game server

4. Credit Line Allocation Program
a. Receive a request to allocate a portion of a credit line to virtual purchases
b. Output credit line
c. Receive preferences for usage for real and virtual purchases
d. Store preferences

5. Credit Line Usage Program
a. Receive a request to purchase a virtual item with a credit card
b. Determine credit line associated with card
c. Determine portion of credit line allocated to virtual purchases
d. Determine if transaction pushes virtual allocation over the credit limit
e. If transaction does not push virtual allocation over the credit limit, process transaction using credit card as payment.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing a virtual environment wherein a player is able to interact with the environment and with other players in the environment other via an avatar;
providing a virtual credit card to a player accessing the virtual environment;
monitoring activities conducted by the player;
determining if any of the monitored activities qualify as a benefit-endowing activity;
awarding a benefit to the player if the transaction qualifies as a benefit-endowing activity, wherein the award of the benefit is independent of any future credit card-based performance by the player.

2. The method of claim 1 wherein the monitored transactions are conducted by the player in the virtual environment.

3. The method of claim 1 wherein the virtual credit card also functions as a real world credit card.

4. The method of claim 3 further wherein the monitored activities are conducted by the player in the real world.

5. The method of claim 1 wherein the benefit endowing activity is making a purchase with the virtual credit card.

6. The method of claim 5 wherein the benefit endowing activity is purchasing a specific item.

7. The method of claim 1 wherein the benefit endowing activity is winning a battle in the virtual environment.

8. The method of claim 1 wherein the benefit endowing activity is achieving an objective in the virtual environment.

9. The method of claim 1 wherein the benefit endowing activity is performing a game management activity.

10. The method of claim 1 wherein the benefit endowing activity is accumulating a predetermined amount of playing time in the game.

11. The method of claim 1 wherein the benefit endowing activity is achieving an objective in a virtual battle.

12. The method of claim 1 wherein the awarded benefit is a fee reduction for playing the game.

13. The method of claim 1 wherein the awarded benefit is virtual currency.

14. The method of claim 1 wherein the awarded benefit is a discount on the purchase price of one or more items in the virtual environment.

15. The method of claim 1 wherein the awarded benefit is the ability to select a given avatar.

16. The method of claim 15 where the given avatar is not otherwise available to players.

16. The method of claim 1 wherein the awarded benefit is the award of a given character attribute.

17. The method of claim 16 wherein the given character attribute is not otherwise available.

18. The method of claim 16 wherein the given character attribute is the ability to perform certain actions.

19. The method of claim 16 wherein the given character attribute is a one or more physical characteristics for an avatar.

20. The method of claim 1 wherein the awarded benefit is access to a portion of the game that is not otherwise accessible.
